(19) United States
(12) Patent Application Publication
(10) Pub. No.: US 2009/0210523 A1
(43) Pub. Date: Aug. 20, 2009

(54) NETWORK MANAGEMENT METHOD AND SYSTEM

(76) Inventor: Matthew Edward Duggan, Surrey (GB)

Correspondence Address: IBM CORP. (WIP);c/o WALDER INTELLECTUAL PROPERTY LAW, P.C., 17330 PRESTON ROAD, SUITE 100B, DALLAS, TX, 75252, US

(21) Appl. No.: 12/031,133

(22) Filed: Feb. 14, 2008

(51) Int. Cl. G06F 15/173

(52) U.S. Cl. 709/223

(57) ABSTRACT

A network management method and system. The method includes identifying and accessing a network device. A set of software loopback interfaces configured for the network device is retrieved. A first set of Internet protocol (IP) addresses associated the set of software loopback interfaces is retrieved. A second set of IP addresses associated with the first set of IP addresses is retrieved. A set of next-hop interfaces is retrieved. A network management topology model based on the network device, the set of software loopback interfaces, the first set of IP addresses, the second set of IP addresses, and the set of next-hop interfaces is generated. The network management topology model indicates that each IP address of the second set of IP addresses that is adjacent to an IP address of the first set of IP addresses is reachable via an associated next-hop interface of the set of next-hop interfaces.

### FIELD OF THE INVENTION

The present invention relates to a method and associated system for generating and updating a network management topology model.

### BACKGROUND OF THE INVENTION

Managing devices that are associated with each other typically comprises a discovery system that includes a time consuming data retrieval/data processing process which may be subject to inaccuracies. Accordingly, there exists a need in the art to overcome at least some of the deficiencies and limitations described herein above.

### SUMMARY OF THE INVENTION

The present invention provides a network management method comprising:

receiving, by a computing system, first identification data associated with a first network device;

accessing, by said computing system, said first network device;

retrieving, by said computing system from said first network device, a first set of software loopback interfaces configured for said first network device;

retrieving, by said computing system, a first set of Internet protocol (IP) addresses associated said first set of software loopback interfaces, wherein each IP address of said first set of IP addresses is associated with a software loopback interface of said first set of software loopback interfaces;

retrieving, by said computing system, a second set of IP addresses associated with said first set of IP addresses, wherein each IP address of said second set of IP addresses is adjacent to an IP address of said first set of IP addresses in accordance with a first network protocol;

retrieving, by said computing system, a first set of next-hop interfaces, wherein each next-hop interface of said first set of next-hop interfaces is associated with an IP address of said second set of IP addresses;

generating, by said computing system, a network management topology model based on said first network device, said first set of software loopback interfaces, said first set of IP addresses, said second set of IP addresses, and said first set of next-hop interfaces, wherein said network management topology model indicates that each said IP address of said second set of IP addresses that is adjacent to an IP address of said first set of IP addresses is reachable via at least one associated next-hop interface of said first set of next-hop interfaces; and

storing, by said computing system, said network management topology model.

The present invention provides a computing system comprising a processor coupled to a computer-readable memory unit, said memory unit comprising instructions that when executed by the processor implements a network management method, said method comprising:

receiving, by said computing system, first identification data associated with a first network device;

accessing, by said computing system, said first network device;

retrieving, by said computing system from said first network device, a first set of software loopback interfaces configured for said first network device;

retrieving, by said computing system, a first set of Internet protocol (IP) addresses associated said first set of software loopback interfaces, wherein each IP address of said first set of IP addresses is associated with a software loopback interface of said first set of software loopback interfaces;

retrieving, by said computing system, a second set of IP addresses associated with said first set of IP addresses, wherein each IP address of said second set of IP addresses is adjacent to an IP address of said first set of IP addresses in accordance with a first network protocol;

retrieving, by said computing system, a first set of next-hop interfaces, wherein each next-hop interface of said first set of next-hop interfaces is associated with an IP address of said second set of IP addresses;

generating, by said computing system, a network management topology model based on said first network device, said first set of software loopback interfaces, said first set of IP addresses, said second set of IP addresses, and said first set of next-hop interfaces, wherein said network management topology model indicates that each said IP address of said second set of IP addresses that is adjacent to an IP address of said first set of IP addresses is reachable via at least one associated next-hop interface of said first set of next-hop interfaces; and

storing, by said computing system, said network management topology model.

The present invention provides a computer program product, comprising a computer readable medium comprising a computer readable program code embodied therein, said computer readable program code adapted to implement a network management method within a computing system comprising a computer-readable memory unit, said method comprising:

receiving, by said computing system, first identification data associated with a first network device;

accessing, by said computing system, said first network device;

retrieving, by said computing system from said first network device, a first set of software loopback interfaces configured for said first network device;

retrieving, by said computing system, a first set of Internet protocol (IP) addresses associated said first set of software loopback interfaces, wherein each IP address of said first set of IP addresses is associated with a software loopback interface of said first set of software loopback interfaces;

retrieving, by said computing system, a second set of IP addresses associated with said first set of IP addresses, wherein each IP address of said second set of IP addresses is adjacent to an IP address of said first set of IP addresses in accordance with a first network protocol;

retrieving, by said computing system, a first set of next-hop interfaces, wherein each next-hop interface of said first set of next-hop interfaces is associated with an IP address of said second set of IP addresses;

generating, by said computing system, a network management topology model based on said first network device, said first set of software loopback interfaces, said first set of IP addresses, said second set of IP addresses, and said first set of next-hop interfaces, wherein said network management topology model indicates that each said IP address of said second set of IP addresses that is adjacent to an IP address of said first set of IP addresses is reachable via at least one associated next-hop interface of said first set of next-hop interfaces; and

storing, by said computing system, said network management topology model.

The present invention advantageously provides a simple method and associated system capable of managing devices that are associated with each other.

### BRIEF DESCRIPTION OF THE DRAWINGS

FIG. 1 illustrates a system for discovering a network and generating a network topology model for the network, in accordance with embodiments of the present invention.

FIG. 2 illustrates a subset of the system of FIG. 1, in accordance with embodiments of the present invention.

FIG. 3 illustrates a system comprising next-hop interfaces, in accordance with embodiments of the present invention.

FIG. 4 illustrates a flowchart describing an algorithm used by the system of FIG. 1, in accordance with embodiments of the present invention.

FIG. 5 illustrates a computer apparatus used for discovering a network and generating a network topology model for the network, in accordance with embodiments of the present invention.

### DETAILED DESCRIPTION OF THE INVENTION

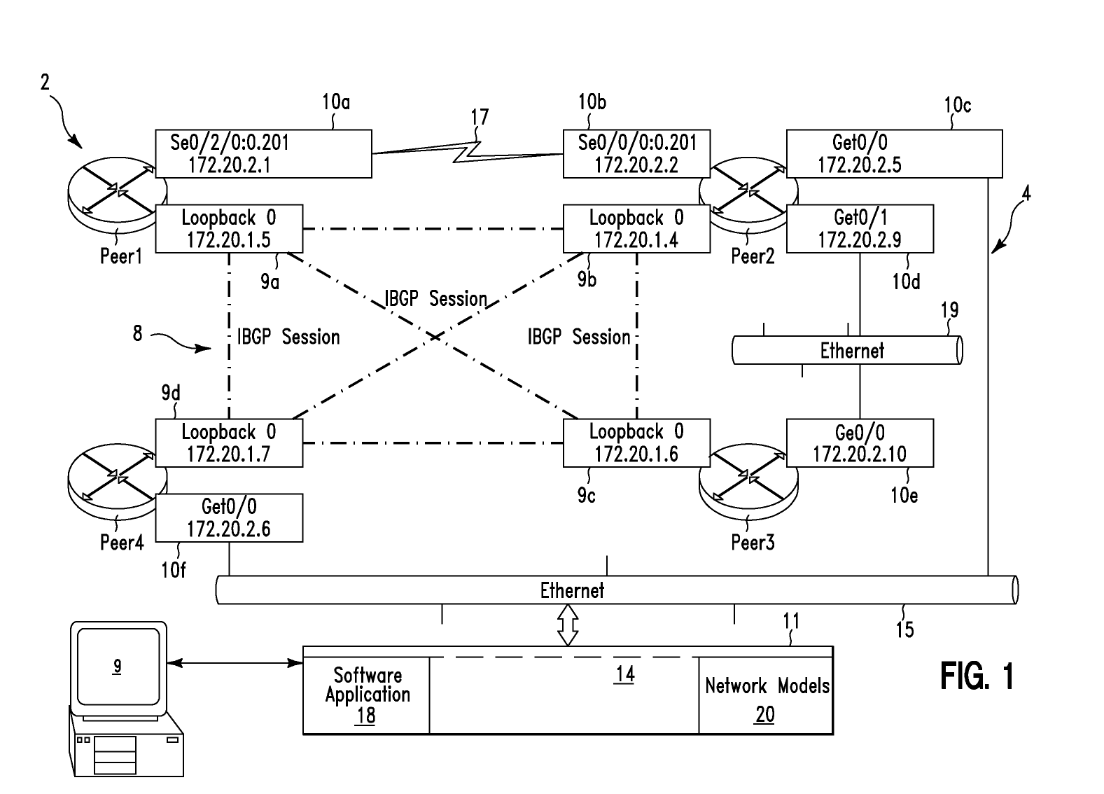

FIG. 1 illustrates a system 2 for discovering a network 4 and generating a network topology model for network 4, in accordance with embodiments of the present invention. System 2 allows for generation of a network model incorporating adjacencies using software loopback interfaces and identifies a local next-hop interface.

Managing a network (e.g., network 4) may require generating an accurate network model, displaying the network model, and event processing/notification capabilities. System 2 provides:

1. Network and network device discovery capabilities.
2. A database to store discovered network topology and related alarms.
3. An active/passive network monitoring system.
4. An event collection and processing capability to assess the impact of events on the managed network (e.g., a Root Cause Analysis (RCA)
5. A configuration system.
6. A graphical user interface (GUI) for visualization and manipulation of the discovered network, devices, and alarms.

Network 4 may comprise a heterogeneous network (i.e., consisting of network devices manufactured by a number of vendors and types including, inter alia, routers, switches, servers and firewalls). Routers (e.g., routers Peer1 . . . Peer4 in FIG. 1) typically run a number of protocols, such as, inter alia, OSPF (open shortest path first) and BGP (border gateway protocol).

Software application 18 provides network and network device (e.g., routers Peer1 . . . Peer4 in FIG. 1) discovery capabilities. User-supplied configuration information may be used by software application 18 to determine which network devices should be discovered (e.g., via: IP subnets and/or device type that represents one or more scopes). Although the network devices described in FIG. 1 are routers, note that the network devices may comprise any type of device including, inter alia, switches, servers, firewalls, etc.

Routing protocols used in network 4 (e.g., BGP) typically form adjacencies between neighboring, but not necessarily physically-connected, devices for the purpose of exchanging routing information. Adjacencies are formed between the device's physical and/or virtual interfaces (e.g., Ethernet interfaces, frame relay interfaces, software loopback interfaces, etc). A software loopback interface is defined herein as a software-only virtual-interface that emulates a physical interface but cannot fail like a physical interface. Packets routed to software loopback interface IP addresses are internally rerouted by the network device and processed locally. The characteristic of software loopback interfaces staying up in the event of an adjacency-affecting interface-failure (e.g., a port failure) is frequently exploited by routing protocols such as OSPF and BGP because their use ensures that the exchange of routing information may continue as long as redundant paths exist between devices subject to the adjacency failure.

Resource models used by software application 18 provide capabilities to model various aspects of network 4 and devices (e.g., routers Peer1 . . . Peer4). Capabilities may include, inter alia:

1. An ability to model the composition of devices with respect to physical components (e.g., cards, slots, ports, power supplies, etc)
2. An ability to model the composition of logical components (e.g., interfaces, network technologies, aspects of configuration, etc).

Resource models may include the capability to model specific technologies. For example, OSPF, BGP, and aspects common to a number of technologies, such as, inter alia, IP routes including characteristics such as next-hops, destination IP address, metrics, and the relationship between a next-hop's relationship to the local interface used to transmit data to next hop.

System 2 in FIG. 1 illustrates an example where software application 18 is used to discover a network (e.g., network 4) implementing a BGP routing protocol. Software application 18 is additionally able to retrieve additional information such as, inter alia, interfaces, IP addresses, and OSPF adjacencies from the network devices. Note that although BGP is being used as an example, system 2 of FIG. 1 is additionally applicable to other routing protocols, such as OSPF, that may form adjacencies using software loopback interfaces.

System 2 of FIG. 1 comprises a network 4 connected to a computing system 11 through an Ethernet 15. Computing system 11 may comprise any type of computing system(s) including, inter alia, a personal computer (PC), a server computer, a database computer, etc. Computing system 11 comprises a memory system 14. Memory system 14 comprises a software application 18 and network management topology models 20. System 2 may comprise an optional access terminal 9 connected to computing system 11. Software application 18 controls all functions associated with retrieving data from network 4 and generating (and updating) network models 20 associated with network 4. Optional access terminal 9 may be used to access, execute, and/or update software application 18.

Network 4 comprises a network with iBGP (i.e., internal BGP where the routers Peer1 . . . Peer4 are members of a same BGP autonomous system) sessions 8 (i.e., as illustrated by dashed lines 8) between four BGP routers Peer1 . . . Peer4. The iBGP sessions 8 are formed between software loopback interfaces 9a . . . 9d but in order for the iBGP sessions 8 to be established, routers Peer1 . . . Peer4 must know how to route traffic out of other interfaces to IP addresses used by software loopback interfaces 9a . . . 9d. Routers Peer1 . . . Peer4 have the ability to perform such routing through the use of static routes and/or an IGP (Interior Gateway Protocol) such as OSPF.

The following steps illustrate a description of network 4.

1. Routers Peer1 . . . Peer4 are running a BGP routing protocol.
2. Each of routers Peer1 . . . Peer4 is configured to use a software loopback interface a software loopback interface of software loopback interfaces 9a . . . 9d.
3. Each software loopback interface 9a . . . 9d is configured to use an IPv4 address.
4. Router Peer1 is associated with software loopback interface 9a. Software loopback interface 9a is configured to use the IPv4 address 172.20.1.5.
5. Router Peer2 is associated with software loopback interface 9b. Software loopback interface 9a is configured to use the IPv4 address 172.20.1.4.
6. Router Peer3 is associated with software loopback interface 9c. Software loopback interface 9c is configured to use the IPv4 address 172.20.1.6.
7. Router Peer4 is associated with software loopback interface 9d. Software loopback interface 9d is configured to use the IPv4 address 172.20.1.7.
8. Each of routers Peer1 . . . Peer4 has been configured to have an iBGP session with an IP address associated with each other router's software loopback interface's 9a . . . 9d resulting in routers Peer1 . . . Peer4 iBGP sessions that are ‘fully meshed’ and not dependent on the physical topology between routers Peer1 . . . Peer4.
9. Each of the routers Peer1 . . . Peer4 has another interface (i.e., interfaces 10a . . . 10f) through which they connect.
10. Router Peer1 is connected through interface 17 to router 7b via frame-relay interfaces 10a and 10b respectively.
11. Router Peer2 is connected through interface 19 to router 7c via gigabit Ethernet interfaces 10d and 10e respectively.
12. Router Peer2 is connected through interface 15 to router 7d via gigabit Ethernet interfaces 10c and 10f respectively.
13. Routers Peer1 . . . Peer4 do not have to be directly connected in order for an adjacency between the software loopback interfaces 9a . . . 9d to be formed (i.e. an adjacency between router Peer1 and router Peer4 is formed via router Peer2).
14. In order for an adjacency between software loopback interface 9a associated with router Peer1 and software loopback interface 9d associated with router Peer4 to be established, traffic must flow through router Peer2 so the total set of interfaces used are interfaces 9a, 10a, 10b, 10c, 10f, and 9d. In this scenario, each of the routers Peer1 . . . Peer4 would make use of an IGP protocol such as OSPF in order to carry the routes toward each other's software loopback interface IP address. Assume that all of routers Peer1 . . . Peer4 are in the same OSPF domain and a same OSPF area 0.0.0.0. Each of routers Peer1 . . . Peer4 would be configured to use a software loopback interface as the update-source for each BGP neighbor. The following configuration fragment demonstrates how router Peer1 may be configured. Assume that the BGP autonomous system in which the devices are configured is:
64512. hostname Peer1
!

### Interface Loopback 9a

ip address 172.20.1.5 255.255.255.255
!
router bgp 64512
network 172.20.0.0 mask 255.255.192.0
neighbor 172.20.1.4 remote-as 64512
neighbor 172.20.1.4 update-source Loopback9a
neighbor 172.20.1.6 remote-as 64512
neighbor 172.20.1.6 update-source Loopback9a
neighbor 172.20.1.7 remote-as 64512
neighbor 172.20.1.7 update-source Loopback9a

The previous description of FIG. 1 describes a process in which software application 18 has discovered network devices (i.e., routers Peer1 . . . Peer4) and adjacencies for the devices.

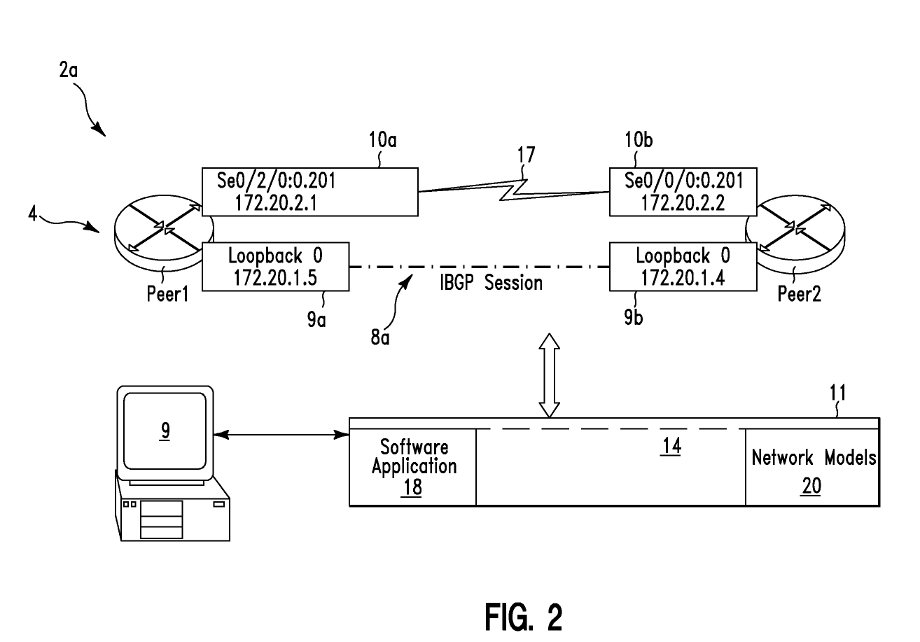

FIG. 2 illustrates a subset 2a of system 2 in FIG. 1, in accordance with embodiments of the present invention. Software application 18 executes the following example steps against router Peer1:

1. Software application 18 has found router Peer1 through use of an ICMP ‘ping’ poll of its software loopback interface 9a comprising IP address 172.20.1.5.
2. Software application 18 retrieves the name of router Peer1.
3. Software application 18 retrieves the set of IP addresses and which interfaces they belong to from Peer1 such that any subsequent ICMP ping polls of its addresses may be correlated. For example, if it pings the address 172.20.2.1 configured on interface 10a, it may resolve that they are both related to Peer1.
4. Assume that software application 18 is capable of and has been configured to retrieve the BGP adjacencies from Peer1 (i.e., iBGP session 8a between Peer 1 and router Peer 2. Software application 18 does this by using data from memory system 14. This connection will belong to the BGP part of software application's 18 network model.
5. Assume that software application 18 is capable of and has been configured to retrieve OSPF adjacencies from Peer1. In this instance, this adjacency information is retrieved from memory system 14.
6. Once the data has been retrieved from Peer 1, the device model is constructed such that Peer1 has an associated set of interfaces, IP addresses, and adjacencies which are members of the OSPF and BGP related sections of the network model as necessary (i.e. the adjacency between interface 10a configured with the IP address 172.20.2.1 and IP address 172.20.2.2 for interface 10b) is considered to be an OSPF adjacency). The adjacency between the software loopback interface 9a configured with the IP address 172.20.1.5 and software loopback interface 9a comprising IP address 172.20.1.4 is considered to be a BGP adjacency.
7. Assume that similar steps are repeated for each device (Peer2-thru-Peer4) in network 4 and assume that some processing capability is able to populate the device models, such that name, interface, and IP address content is modeled, and that the adjacencies between the device interfaces are modeled.

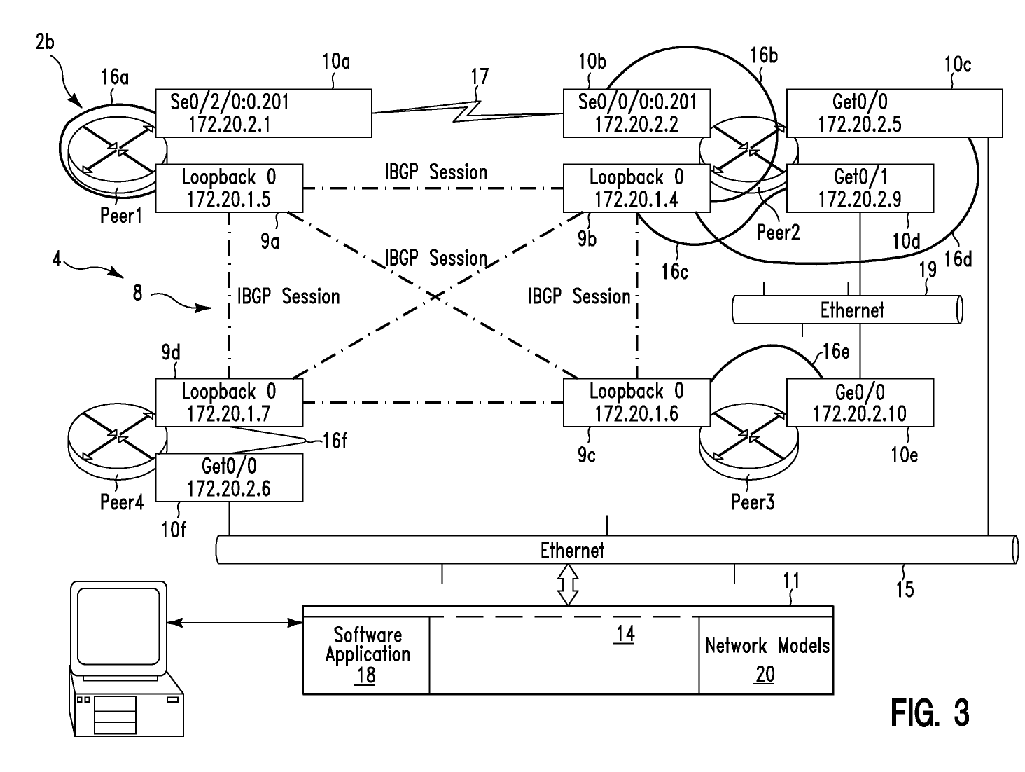

FIG. 3 illustrates a system 2b comprising the system 2 of FIG. 1 with next-hop interfaces 16a . . . 16f, in accordance with embodiments of the present invention. The previous description of FIG. 1 describes a process in which software application 18 has discovered network devices (i.e., routers Peer 1 . . . Peer4) and adjacencies for the devices. In FIG. 3, software application 18 has discovered relationships between a software loopback interface, its adjacent IP address (via the iBGP session), and the next-hop interface(s) through which the adjacent address may be sent data.

The relationships are described as follows:

1. Line 16a between software loopback interface 9a and interface 10a represents a next-hop relationship for the adjacency between software loopback interface 9a on Peer1 and software loopback interface 9b on Peer2. Interface 10a is also the next-hop interface to reach Peer3 and Peer4.
2. Line 16b between software loopback interface 9b and interface 10b represents a next-hop interface relationship for the adjacency between software loopback interface 9b on Peer2 and software loopback interface 9a on Peer1.
3. Line 16c between software loopback interface 9b and interface 10d represents the next-hop interface relationship for the adjacency between software loopback interface 9b on Peer2 and software loopback interface 9c on Peer3.
4. Line 16d between software loopback interface 9b and interface 10c represents a next-hop interface relationship for the adjacency between software loopback interface 9b on Peer2 and software loopback interface 9d on Peer4.
5. Line 16e between software loopback interface 9c and interface 10e represents next-hop interface relationship for the adjacency between software loopback interface 9c on Peer3 and software loopback interface 9b on Peer2. Similarly, interface 10e is also the next-hop interface to reach Peer1 and Peer4.
6. Line 16f between interfaces software loopback interface 9d and interface 10f represents a next-hop interface relationship for the adjacency between software loopback interface 9d on Peer4 and software loopback interface 9a on Peer1. Similarly, interface 10f is also the next-hop interface to reach Peer2 and Peer3.

Software application 18 executes the following processes for identifying a relationship between a software loopback interface, its adjacent IP address (via the iBGP session), and the next-hop interface(s) through which the adjacent address can be sent in order to generate a network management topology model:

1. Software application 18 executes a process for quickly identifying a relationship between a software loopback interface and a local next-hop interface used to reach an adjacent device when the adjacency is formed using a software loopback interface.
2. Software application 18 executes an on-demand process for executing highly granular updates to a network management topology model.
3. Software application 18 executes an algorithm that may be used to resolve the relationship between an adjacency using a software loopback interface and a next-hop interface toward the remote peer such that the relationship may be added to the network management application's topology model.

The following algorithm executed by software application 18 is used to generate a network management application's topology model:

1. Software application 18 is instructed to run against a specific device (e.g., router 7a) in a managed network. The identity of the device is provided to as either a hostname, which may or may not be fully-qualified, or an IPv4 or IPv6 address. Let this device be known as d.
2. Once the device d has been accessed, a query is made to retrieve a set of software loopback interfaces configured on the device. If device d does not make use of any software loopback interfaces, further processing must stop. If software loopback interfaces are retrieved from the device d, let the set of software loopback interfaces be known as i[ ].
3. For each software loopback interface i in the set i[ ], retrieve the set of IP addresses configured on each software loopback interface. Let this set of IP addresses be known as ip[ ].
4. Once the set of IP addresses configured by the software loopback interfaces have been retrieved (i.e., for each IP address ip in the set of IP addresses i[ ]) retrieve the set of IP addresses considered to be adjacent to ip. If there are no adjacencies of ip, process the next IP address in the set of IP addresses ip[ ]. If there are adjacencies of ip, let the set of adjacent IP addresses be known as adj[ ].
5. Once the set of adjacent IP addresses of each software loopback interface IP address has been retrieved, for each adjacency adj, retrieve the set of next-hop interfaces that may be used to reach adj (i.e., the interfaces through which traffic is routed toward the adjacency). If there are no next-hop interfaces, further processing must stop. If there are next-hop interfaces, let this set of interfaces be known as ih[ ].
6. For each next hop interface nh in the set of next-hop interfaces nh[ ], associate the iih with adj such that software application's 18 topology model may represent that that each adjacency adj is reachable via nh.
7. Processing terminates once all of the software loopback interfaces, configured IP addresses, and adjacencies have been processed.

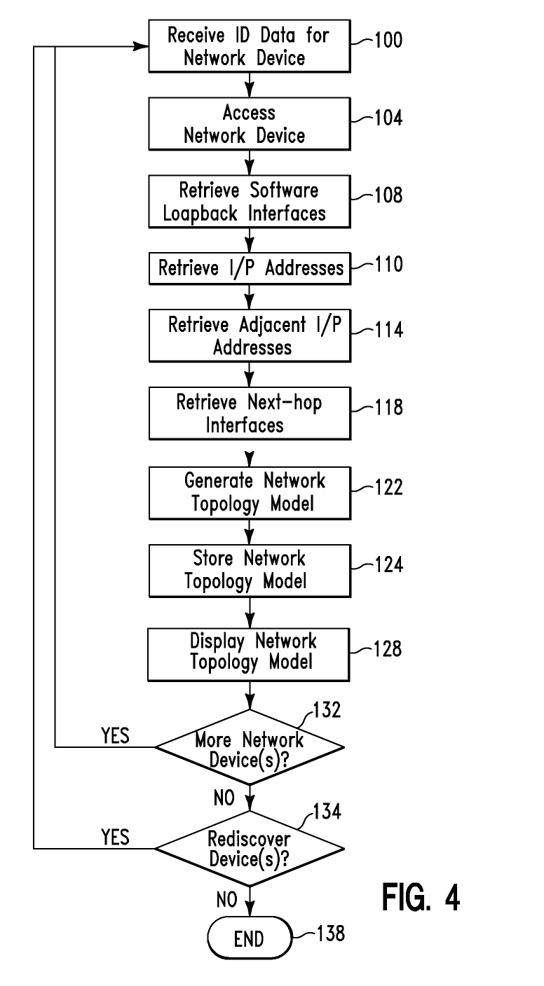

FIG. 4 illustrates a flowchart describing an algorithm used by system 2 of FIG. 1 for discovering network 4 (of FIG. 1) and generating a network topology model for network 4, in accordance with embodiments of the present invention. In step 100, a computing system (e.g., computing system 11 of FIG. 1) receives identification data associated with a network device. In step 104, the computing system accesses the network device. In step 108, the computing system retrieves from the network device, a set of software loopback interfaces configured for the first network device. In step 110, the computing system retrieves a first set of Internet protocol (IP) addresses associated the set of software loopback interfaces. Each IP address of the first set of IP addresses is associated with a software loopback interface of the set of software loopback interfaces. In step 114, the computing system retrieves a second set of IP addresses associated with the first set of IP addresses. Each IP address of the second set of IP addresses is adjacent to an IP address of the first set of IP addresses in accordance with a first network protocol. In step 118, the computing system retrieves a set of next-hop interfaces. Each next-hop interface of the set of next-hop interfaces is associated with an IP address of the second set of IP addresses. In step 122, the computing system generates a network management topology model (and optional report) based on the device, the set of software loopback interfaces, the first set of IP addresses, the second set of IP addresses, and the set of next-hop interfaces. The network management topology model indicates that each said IP address of the second set of IP addresses that is adjacent to an IP address of the first set of IP addresses is reachable via at least one associated next-hop interface of the set of next-hop interfaces. In step 124, the computing system stores the network management topology model (and optional report). In step 128, the computing system optionally displays the network management topology model (and optional report) via terminal 9 in FIG. 1. In step 132, it is determined if a next network device in network 4 of FIG. 1 should be discovered. If in step 132, it is determined that the next network device in network 4 of FIG. 1 should be discovered then steps 100-128 are repeated for the next network device and a modified network management topology model (and optional report) is generated. These steps may be continuously repeated for any number of network devices. If in step 132, it is determined that the next network device in network 4 of FIG. 1 should not be discovered then in step 134 it is determined if any of the previously discovered network devices should be rediscovered (i.e., updated). If in step 134 it is determined that any of the previously discovered network devices should be rediscovered then steps 100-128 are repeated for the previously discovered network devices and a modified network management topology model (and optional report) is generated. These steps may be continuously repeated any number of times using any number of IP addresses, software loop-back interfaces, and next-hop interfaces. Note that each time steps 100-128 are executed for a given network device (i.e., each iteration), the computing system may discover the same IP addresses, software loop-back interfaces, and next-hop interfaces (for the given device) and/or different IP addresses, software loop-back interfaces, and next-hop interfaces (for the given device). If in step 134 it is determined that any of the previously discovered network devices should not be rediscovered then the process terminates in step 138.

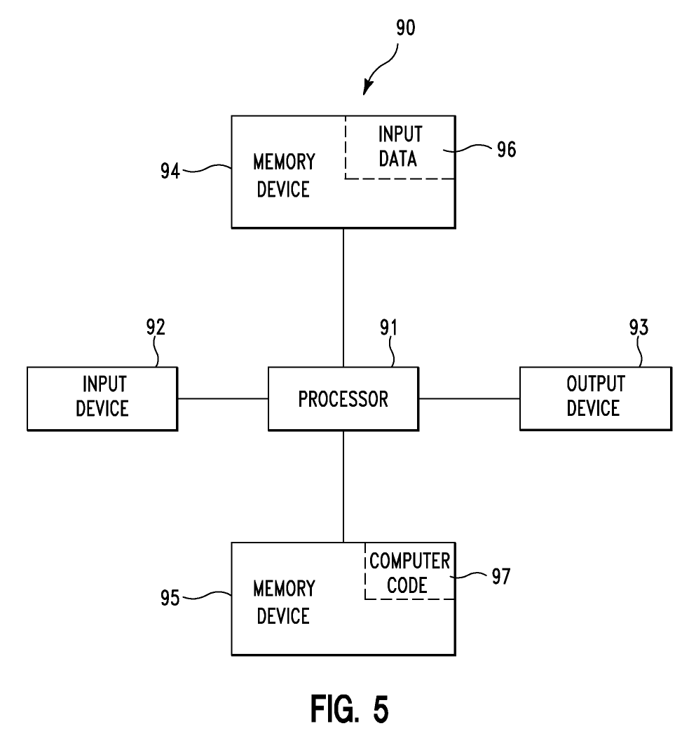

FIG. 5 illustrates a computer apparatus 90 (e.g., computing system 11 of FIG. 1) used for discovering a network and generating a network topology model for the network, in accordance with embodiments of the present invention. The computer system 90 comprises a processor 91, an input device 92 coupled to the processor 91, an output device 93 coupled to the processor 91, and memory devices 94 and 95 each coupled to the processor 91. The input device 92 may be, inter alia, a keyboard, a mouse, etc. The output device 93 may be, inter alia, a printer, a plotter, a computer screen, a magnetic tape, a removable hard disk, a floppy disk, etc. The memory devices 94 and 95 may be, inter alia, a hard disk, a floppy disk, a magnetic tape, an optical storage such as a compact disc (CD) or a digital video disc (DVD), a dynamic random access memory (DRAM), a read-only memory (ROM), etc. The memory device 95 includes a computer code 97. The computer code 97 includes algorithms (e.g., the algorithm of FIG. 4) for discovering a network and generating a network topology model for the network. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices not shown in FIG. 5) may comprise the algorithm of FIG. 4 and may be used as a computer usable medium (or a computer readable medium or a program storage device) having a computer readable program code embodied therein and/or having other data stored therein, wherein the computer readable program code comprises the computer code 97. Generally, a computer program product (or, alternatively, an article of manufacture) of the computer system 90 may comprise said computer usable medium (or said program storage device).

Still yet, any of the components of the present invention could be created, integrated, hosted, maintained, deployed, managed, serviced, etc. by a service provider who offers to discover a network and generate a network topology model for the network. Thus the present invention discloses a process for deploying, creating, integrating, hosting, maintaining, and/or integrating computing infrastructure, comprising integrating computer-readable code into the computer system 90, wherein the code in combination with the computer system 90 is capable of performing a method for discovering a network and generating a network topology model for the network. In another embodiment, the invention provides a business method that performs the process steps of the invention on a subscription, advertising, and/or fee basis. That is, a service provider, such as a Solution Integrator, could offer to perform a process for discovering a network and generating a network topology model for the network. In this case, the service provider can create, maintain, support, etc. a computer infrastructure that performs the process steps of the invention for one or more customers. In return, the service provider can receive payment from the customer(s) under a subscription and/or fee agreement and/or the service provider can receive payment from the sale of advertising content to one or more third parties.

While FIG. 5 shows the computer system 90 as a particular configuration of hardware and software, any configuration of hardware and software, as would be known to a person of ordinary skill in the art, may be utilized for the purposes stated supra in conjunction with the particular computer system 90 of FIG. 5. For example, the memory devices 94 and 95 may be portions of a single memory device rather than separate memory devices.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A network management method comprising:
receiving, by a computing system, first identification data associated with a first network device;
accessing, by said computing system, said first network device;
retrieving, by said computing system from said first network device, a first set of software loopback interfaces configured for said first network device;
retrieving, by said computing system, a first set of Internet protocol (IP) addresses associated said first set of software loopback interfaces, wherein each IP address of said first set of IP addresses is associated with a software loopback interface of said first set of software loopback interfaces;
retrieving, by said computing system, a second set of IP addresses associated with said first set of IP addresses, wherein each IP address of said second set of IP addresses is adjacent to an IP address of said first set of IP addresses in accordance with a first network protocol;
retrieving, by said computing system, a first set of next-hop interfaces, wherein each next-hop interface of said first set of next-hop interfaces is associated with an IP address of said second set of IP addresses;
generating, by said computing system, a network management topology model based on said first network device, said first set of software loopback interfaces, said first set of IP addresses, said second set of IP addresses, and said first set of next-hop interfaces, wherein said network management topology model indicates that each said IP address of said second set of IP addresses that is adjacent to an IP address of said first set of IP addresses is reachable via at least one associated next-hop interface of said first set of next-hop interfaces; and
storing, by said computing system, said network management topology model.

2. The method of claim 1, further comprising:
receiving, by said computing system, second identification data associated with a second network device;
accessing, by said computing system, said second network device;
retrieving, by said computing system from said second network device, a second set of software loopback interfaces configured for said second network device;
retrieving, by said computing system, a third set of IP addresses associated said second set of software loopback interfaces, wherein each IP address of said third set of IP addresses is associated with a software loopback interface of said second set of software loopback interfaces;
retrieving, by said computing system, a fourth set of IP addresses associated said third set of IP addresses, wherein each IP address of said fourth set of IP addresses is adjacent to an IP address of said third set of IP addresses in accordance with a second network protocol;
retrieving, by said computing system, a second set of next-hop interfaces, wherein each next-hop interface of said second set of next-hop interfaces is associated with an IP address of said fourth set of IP addresses;
generating, by said computing system, a first modified network management topology model based on said network management topology model, said second network device, said second set of software loopback interfaces, said third set of IP addresses, said fourth set of IP addresses, and said second set of next-hop interfaces, wherein said network management topology model indicates that each said IP address of said second set of IP addresses that is adjacent to an IP address of said first set of IP addresses is reachable via at least one associated next-hop interface of said first set of next-hop interfaces and each said IP address of said fourth set of IP addresses that is adjacent to an IP address of said third set of IP addresses is reachable via at least one associated next-hop interface of said second set of next-hop interfaces; and
storing, by said computing system, said modified network management topology model.

3. The method of claim 2, further comprising:
retrieving, by said computing system from said first network device, a third set of software loopback interfaces configured for said first network device;
retrieving, by said computing system, a fifth set of IP addresses associated said third set of software loopback interfaces, wherein each IP address of said fifth set of IP addresses is associated with a software loopback interface of said third set of software loopback interfaces;
retrieving, by said computing system, a sixth set of IP addresses associated with said fifth set of IP addresses, wherein each IP address of said sixth set of IP addresses is adjacent to an IP address of said fifth set of IP addresses in accordance with a third network protocol;
retrieving, by said computing system, a third set of next-hop interfaces, wherein each next-hop interface of said third set of next-hop interfaces is associated with an IP address of said sixth set of IP addresses;
generating, by said computing system, a second updated network management topology model based on said first updated network management topology model, said third set of software loopback interfaces, said fifth set of IP addresses, said sixth set of IP addresses, and said third set of next-hop interfaces, wherein said second updated network management topology model indicates that each said IP address of said fourth set of IP addresses that is adjacent to an IP address of said third set of IP addresses is reachable via at least one associated next-hop interface of said second set of next-hop interfaces and that each said IP address of said sixth set of IP addresses that is adjacent to an IP address of said fifth set of IP addresses is reachable via at least one associated next-hop interface of said third set of next-hop interfaces; and
storing, by said computing system, said second updated network management topology model.

4. The method of claim 2, further comprising:
retrieving, by said computing system from said first network device, a third set of software loopback interfaces configured for said first network device;
retrieving, by said computing system, a fifth set of IP addresses associated said third set of software loopback interfaces, wherein each IP address of said fifth set of IP addresses is associated with a software loopback interface of said third set of software loopback interfaces;
retrieving, by said computing system, a sixth set of IP addresses associated with said fifth set of IP addresses, wherein each IP address of said sixth set of IP addresses is adjacent to an IP address of said fifth set of IP addresses in accordance with a third network protocol;
retrieving, by said computing system, a third set of next-hop interfaces, wherein each next-hop interface of said third set of next-hop interfaces is associated with an IP address of said sixth set of IP addresses;
retrieving, by said computing system from said second network device, a fourth set of software loopback interfaces configured for said second network device;
retrieving, by said computing system, a seventh set of IP addresses associated said fourth set of software loopback interfaces, wherein each IP address of said seventh set of IP addresses is associated with a software loopback interface of said fourth set of software loopback interfaces;
retrieving, by said computing system, an eighth set of IP addresses associated with said seventh set of IP addresses, wherein each IP address of said eighth set of IP addresses is adjacent to an IP address of said seventh set of IP addresses in accordance with a fourth network protocol;
retrieving, by said computing system, a fourth set of next-hop interfaces, wherein each next-hop interface of said fourth set of next-hop interfaces is associated with an IP address of said eighth set of IP addresses;
generating, by said computing system, a second updated network management topology model based on said third set of software loopback interfaces, said fourth set of software loopback interfaces, said fifth set of IP addresses, said sixth set of IP addresses, said seventh set of IP addresses, said eighth set of IP addresses, said third set of next-hop interfaces, and said fourth set of next-hop interfaces, wherein said second updated network management topology model indicates that each said IP address of said sixth set of IP addresses that is adjacent to an IP address of said fifth set of IP addresses is reachable via at least one associated next-hop interface of said third set of next-hop interfaces and that each said IP address of said eighth set of IP addresses that is adjacent to an IP address of said seventh set of IP addresses is reachable via at least one associated next-hop interface of said fourth set of next-hop interfaces; and
storing, by said computing system, said second updated network management topology model.

5. The method of claim 2, further comprising:
displaying, by said computing system, a portion of said first modified network management topology model.

6. The method of claim 1, further comprising:
retrieving, by said computing system from said first network device, a second set of software loopback interfaces configured for said first network device;
retrieving, by said computing system, a third set of IP addresses associated said second set of software loopback interfaces, wherein each IP address of said third set of IP addresses is associated with a software loopback interface of said second set of software loopback interfaces;
retrieving, by said computing system, a fourth set of IP addresses associated with said third set of IP addresses, wherein each IP address of said fourth set of IP addresses is adjacent to an IP address of said third set of IP addresses in accordance with a second network protocol;
retrieving, by said computing system, a second set of next-hop interfaces, wherein each next-hop interface of said second set of next-hop interfaces is associated with an IP address of said fourth set of IP addresses;
generating, by said computing system, an updated network management topology model based on said network management topology model, said second set of software loopback interfaces, said third set of IP addresses, said fourth set of IP addresses, and said second set of next-hop interfaces, wherein said updated network management topology model indicates that each said IP address of said fourth set of IP addresses that is adjacent to an IP address of said third set of IP addresses is reachable via at least one associated next-hop interface of said second set of next-hop interfaces; and
storing, by said computing system, said updated network management topology model.

7. The method of claim 1, wherein said first network device comprises a device selected form the group consisting of a router, a switch, a server, and a firewall.

8. The method of claim 1, further comprising:
generating, by said computing system, a report associated with said network management topology model; and
storing, by said computing system, said report.

9. A computing system comprising a processor coupled to a computer-readable memory unit, said memory unit comprising instructions that when executed by the processor implements a network management method, said method comprising:
receiving, by said computing system, first identification data associated with a first network device;
accessing, by said computing system, said first network device;
retrieving, by said computing system from said first network device, a first set of software loopback interfaces configured for said first network device;
retrieving, by said computing system, a first set of Internet protocol (IP) addresses associated said first set of software loopback interfaces, wherein each IP address of said first set of IP addresses is associated with a software loopback interface of said first set of software loopback interfaces;
retrieving, by said computing system, a second set of IP addresses associated with said first set of IP addresses, wherein each IP address of said second set of IP addresses is adjacent to an IP address of said first set of IP addresses in accordance with a first network protocol;
retrieving, by said computing system, a first set of next-hop interfaces, wherein each next-hop interface of said first set of next-hop interfaces is associated with an IP address of said second set of IP addresses;
generating, by said computing system, a network management topology model based on said first network device, said first set of software loopback interfaces, said first set of IP addresses, said second set of IP addresses, and said first set of next-hop interfaces, wherein said network management topology model indicates that each said IP address of said second set of IP addresses that is adjacent to an IP address of said first set of IP addresses is reachable via at least one associated next-hop interface of said first set of next-hop interfaces; and
storing, by said computing system, said network management topology model.

10. The computing system of claim 9, wherein said method further comprises:
receiving, by said computing system, second identification data associated with a second network device;
accessing, by said computing system, said second network device;
retrieving, by said computing system from said second network device, a second set of software loopback interfaces configured for said second network device;
retrieving, by said computing system, a third set of IP addresses associated said second set of software loopback interfaces, wherein each IP address of said third set of IP addresses is associated with a software loopback interface of said second set of software loopback interfaces;
retrieving, by said computing system, a fourth set of IP addresses associated said third set of IP addresses, wherein each IP address of said fourth set of IP addresses is adjacent to an IP address of said third set of IP addresses in accordance with a second network protocol;
retrieving, by said computing system, a second set of next-hop interfaces, wherein each next-hop interface of said second set of next-hop interfaces is associated with an IP address of said fourth set of IP addresses;
generating, by said computing system, a first modified network management topology model based on said network management topology model, said second network device, said second set of software loopback interfaces, said third set of IP addresses, said fourth set of IP addresses, and said second set of next-hop interfaces, wherein said network management topology model indicates that each said IP address of said second set of IP addresses that is adjacent to an IP address of said first set of IP addresses is reachable via at least one associated next-hop interface of said first set of next-hop interfaces and each said IP address of said fourth set of IP addresses that is adjacent to an IP address of said third set of IP addresses is reachable via at least one associated next-hop interface of said second set of next-hop interfaces; and
storing, by said computing system, said modified network management topology model.

11. The computing system of claim 10, wherein said method further comprises:
retrieving, by said computing system from said first network device, a third set of software loopback interfaces configured for said first network device;
retrieving, by said computing system, a fifth set of IP addresses associated said third set of software loopback interfaces, wherein each IP address of said fifth set of IP addresses is associated with a software loopback interface of said third set of software loopback interfaces;
retrieving, by said computing system, a sixth set of IP addresses associated with said fifth set of IP addresses, wherein each IP address of said sixth set of IP addresses is adjacent to an IP address of said fifth set of IP addresses in accordance with a third network protocol;
retrieving, by said computing system, a third set of next-hop interfaces, wherein each next-hop interface of said third set of next-hop interfaces is associated with an IP address of said sixth set of IP addresses;
generating, by said computing system, a second updated network management topology model based on said first updated network management topology model, said third set of software loopback interfaces, said fifth set of IP addresses, said sixth set of IP addresses, and said third set of next-hop interfaces, wherein said second updated network management topology model indicates that each said IP address of said fourth set of IP addresses that is adjacent to an IP address of said third set of IP addresses is reachable via at least one associated next-hop interface of said second set of next-hop interfaces and that each said IP address of said sixth set of IP addresses that is adjacent to an IP address of said fifth set of IP addresses is reachable via at least one associated next-hop interface of said third set of next-hop interfaces; and
storing, by said computing system, said second updated network management topology model.

12. The computing system of claim 10, wherein said method further comprises:
retrieving, by said computing system from said first network device, a third set of software loopback interfaces configured for said first network device;
retrieving, by said computing system, a fifth set of IP addresses associated said third set of software loopback interfaces, wherein each IP address of said fifth set of IP addresses is associated with a software loopback interface of said third set of software loopback interfaces;
retrieving, by said computing system, a sixth set of IP addresses associated with said fifth set of IP addresses, wherein each IP address of said sixth set of IP addresses is adjacent to an IP address of said fifth set of IP addresses in accordance with a third network protocol;
retrieving, by said computing system, a third set of next-hop interfaces, wherein each next-hop interface of said third set of next-hop interfaces is associated with an IP address of said sixth set of IP addresses;
retrieving, by said computing system from said second network device, a fourth set of software loopback interfaces configured for said second network device;
retrieving, by said computing system, a seventh set of IP addresses associated said fourth set of software loopback interfaces, wherein each IP address of said seventh set of IP addresses is associated with a software loopback interface of said fourth set of software loopback interfaces;
retrieving, by said computing system, an eighth set of IP addresses associated with said seventh set of IP addresses, wherein each IP address of said eighth set of IP addresses is adjacent to an IP address of said seventh set of IP addresses in accordance with a fourth network protocol;
retrieving, by said computing system, a fourth set of next-hop interfaces, wherein each next-hop interface of said fourth set of next-hop interfaces is associated with an IP address of said eighth set of IP addresses;
generating, by said computing system, a second updated network management topology model based on said third set of software loopback interfaces, said fourth set of software loopback interfaces, said fifth set of IP addresses, said sixth set of IP addresses, said seventh set of IP addresses, said eighth set of IP addresses, said third set of next-hop interfaces, and said fourth set of next-hop interfaces, wherein said second updated network management topology model indicates that each said IP address of said sixth set of IP addresses that is adjacent to an IP address of said fifth set of IP addresses is reachable via at least one associated next-hop interface of said third set of next-hop interfaces and that each said IP address of said eighth set of IP addresses that is adjacent to an IP address of said seventh set of IP addresses is reachable via at least one associated next-hop interface of said fourth set of next-hop interfaces; and
storing, by said computing system, said second updated network management topology model.

13. The computing system of claim 10, wherein said method further comprises:
displaying, by said computing system, a portion of said first modified network management topology model.

14. The computing system of claim 9, wherein said method further comprises:
retrieving, by said computing system from said first network device, a second set of software loopback interfaces configured for said first network device;
retrieving, by said computing system, a third set of IP addresses associated said second set of software loopback interfaces, wherein each IP address of said third set of IP addresses is associated with a software loopback interface of said second set of software loopback interfaces;
retrieving, by said computing system, a fourth set of IP addresses associated with said third set of IP addresses, wherein each IP address of said fourth set of IP addresses is adjacent to an IP address of said third set of IP addresses in accordance with a second network protocol;
retrieving, by said computing system, a second set of next-hop interfaces, wherein each next-hop interface of said second set of next-hop interfaces is associated with an IP address of said fourth set of IP addresses;
generating, by said computing system, an updated network management topology model based on said network management topology model, said second set of software loopback interfaces, said third set of IP addresses, said fourth set of IP addresses, and said second set of next-hop interfaces, wherein said updated network management topology model indicates that each said IP address of said fourth set of IP addresses that is adjacent to an IP address of said third set of IP addresses is reachable via at least one associated next-hop interface of said second set of next-hop interfaces; and
storing, by said computing system, said updated network management topology model.

15. The computing system of claim 9, wherein said first network device comprises a device selected form the group consisting of a router, a switch, a server, and a firewall.

16. The computing system of claim 9, wherein said method further comprises:
generating, by said computing system, a report associated with said network management topology model; and
storing, by said computing system, said report.

17. A computer program product, comprising a computer readable medium comprising a computer readable program code embodied therein, said computer readable program code adapted to implement a network management method within a computing system comprising a computer-readable memory unit, said method comprising:
receiving, by said computing system, first identification data associated with a first network device;
accessing, by said computing system, said first network device;
retrieving, by said computing system from said first network device, a first set of software loopback interfaces configured for said first network device;
retrieving, by said computing system, a first set of Internet protocol (IP) addresses associated said first set of software loopback interfaces, wherein each IP address of said first set of IP addresses is associated with a software loopback interface of said first set of software loopback interfaces;
retrieving, by said computing system, a second set of IP addresses associated with said first set of IP addresses, wherein each IP address of said second set of IP addresses is adjacent to an IP address of said first set of IP addresses in accordance with a first network protocol;
retrieving, by said computing system, a first set of next-hop interfaces, wherein each next-hop interface of said first set of next-hop interfaces is associated with an IP address of said second set of IP addresses;
generating, by said computing system, a network management topology model based on said first network device, said first set of software loopback interfaces, said first set of IP addresses, said second set of IP addresses, and said first set of next-hop interfaces, wherein said network management topology model indicates that each said IP address of said second set of IP addresses that is adjacent to an IP address of said first set of IP addresses is reachable via at least one associated next-hop interface of said first set of next-hop interfaces; and
storing, by said computing system, said network management topology model.

18. The computer program product of claim 17, wherein said method further comprises:
receiving, by said computing system, second identification data associated with a second network device;
accessing, by said computing system, said second network device;
retrieving, by said computing system from said second network device, a second set of software loopback interfaces configured for said second network device;
retrieving, by said computing system, a third set of IP addresses associated said second set of software loopback interfaces, wherein each IP address of said third set of IP addresses is associated with a software loopback interface of said second set of software loopback interfaces;
retrieving, by said computing system, a fourth set of IP addresses associated said third set of IP addresses, wherein each IP address of said fourth set of IP addresses is adjacent to an IP address of said third set of IP addresses in accordance with a second network protocol;
retrieving, by said computing system, a second set of next-hop interfaces, wherein each next-hop interface of said second set of next-hop interfaces is associated with an IP address of said fourth set of IP addresses;
generating, by said computing system, a first modified network management topology model based on said network management topology model, said second network device, said second set of software loopback interfaces, said third set of IP addresses, said fourth set of IP addresses, and said second set of next-hop interfaces, wherein said network management topology model indicates that each said IP address of said second set of IP addresses that is adjacent to an IP address of said first set of IP addresses is reachable via at least one associated next-hop interface of said first set of next-hop interfaces and each said IP address of said fourth set of IP addresses that is adjacent to an IP address of said third set of IP addresses is reachable via at least one associated next-hop interface of said second set of next-hop interfaces; and
storing, by said computing system, said modified network management topology model.

19. The computer program product of claim 18, wherein said method further comprises:
retrieving, by said computing system from said first network device, a third set of software loopback interfaces configured for said first network device;
retrieving, by said computing system, a fifth set of IP addresses associated said third set of software loopback interfaces, wherein each IP address of said fifth set of IP addresses is associated with a software loopback interface of said third set of software loopback interfaces;
retrieving, by said computing system, a sixth set of IP addresses associated with said fifth set of IP addresses, wherein each IP address of said sixth set of IP addresses is adjacent to an IP address of said fifth set of IP addresses in accordance with a third network protocol;
retrieving, by said computing system, a third set of next-hop interfaces, wherein each next-hop interface of said third set of next-hop interfaces is associated with an IP address of said sixth set of IP addresses;
generating, by said computing system, a second updated network management topology model based on said first updated network management topology model, said third set of software loopback interfaces, said fifth set of IP addresses, said sixth set of IP addresses, and said third set of next-hop interfaces, wherein said second updated network management topology model indicates that each said IP address of said fourth set of IP addresses that is adjacent to an IP address of said third set of IP addresses is reachable via at least one associated next-hop interface of said second set of next-hop interfaces and that each said IP address of said sixth set of IP addresses that is adjacent to an IP address of said fifth set of IP addresses is reachable via at least one associated next-hop interface of said third set of next-hop interfaces; and
storing, by said computing system, said second updated network management topology model.

20. The computer program product of claim 18, wherein said method further comprises:
retrieving, by said computing system from said first network device, a third set of software loopback interfaces configured for said first network device;
retrieving, by said computing system, a fifth set of IP addresses associated said third set of software loopback interfaces, wherein each IP address of said fifth set of IP addresses is associated with a software loopback interface of said third set of software loopback interfaces;
retrieving, by said computing system, a sixth set of IP addresses associated with said fifth set of IP addresses, wherein each IP address of said sixth set of IP addresses is adjacent to an IP address of said fifth set of IP addresses in accordance with a third network protocol;
retrieving, by said computing system, a third set of next-hop interfaces, wherein each next-hop interface of said third set of next-hop interfaces is associated with an IP address of said sixth set of IP addresses;
retrieving, by said computing system from said second network device, a fourth set of software loopback interfaces configured for said second network device;
retrieving, by said computing system, a seventh set of IP addresses associated said fourth set of software loopback interfaces, wherein each IP address of said seventh set of IP addresses is associated with a software loopback interface of said fourth set of software loopback interfaces;
retrieving, by said computing system, an eighth set of IP addresses associated with said seventh set of IP addresses, wherein each IP address of said eighth set of IP addresses is adjacent to an IP address of said seventh set of IP addresses in accordance with a fourth network protocol;
retrieving, by said computing system, a fourth set of next-hop interfaces, wherein each next-hop interface of said fourth set of next-hop interfaces is associated with an IP address of said eighth set of IP addresses;
generating, by said computing system, a second updated network management topology model based on said third set of software loopback interfaces, said fourth set of software loopback interfaces, said fifth set of IP addresses, said sixth set of IP addresses, said seventh set of IP addresses, said eighth set of IP addresses, said third set of next-hop interfaces, and said fourth set of next-hop interfaces, wherein said second updated network management topology model indicates that each said IP address of said sixth set of IP addresses that is adjacent to an IP address of said fifth set of IP addresses is reachable via at least one associated next-hop interface of said third set of next-hop interfaces and that each said IP address of said eighth set of IP addresses that is adjacent to an IP address of said seventh set of IP addresses is reachable via at least one associated next-hop interface of said fourth set of next-hop interfaces; and
storing, by said computing system, said second updated network management topology model.

21. The computer program product of claim 18, wherein said method further comprises:
displaying, by said computing system, a portion of said first modified network management topology model.

22. The computer program product of claim 17, wherein said method further comprises:
retrieving, by said computing system from said first network device, a second set of software loopback interfaces configured for said first network device;
retrieving, by said computing system, a third set of IP addresses associated said second set of software loopback interfaces, wherein each IP address of said third set of IP addresses is associated with a software loopback interface of said second set of software loopback interfaces;
retrieving, by said computing system, a fourth set of IP addresses associated with said third set of IP addresses, wherein each IP address of said fourth set of IP addresses is adjacent to an IP address of said third set of IP addresses in accordance with a second network protocol;
retrieving, by said computing system, a second set of next-hop interfaces, wherein each next-hop interface of said second set of next-hop interfaces is associated with an IP address of said fourth set of IP addresses;
generating, by said computing system, an updated network management topology model based on said network management topology model, said second set of software loopback interfaces, said third set of IP addresses, said fourth set of IP addresses, and said second set of next-hop interfaces, wherein said updated network management topology model indicates that each said IP address of said fourth set of IP addresses that is adjacent to an IP address of said third set of IP addresses is reachable via at least one associated next-hop interface of said second set of next-hop interfaces; and
storing, by said computing system, said updated network management topology model.

23. The computer program product of claim 17, wherein said first network device comprises a device selected form the group consisting of a router, a switch, a server, and a firewall.

24. The computer program product of claim 17, wherein said method further comprises:
generating, by said computing system, a report associated with said network management topology model; and
storing, by said computing system, said report.
